(19) United States
(12) Patent Application Publication
(10) Pub. No.: US 2009/0169456 A1
(43) Pub. Date: Jul. 2, 2009

(54) Apparatus for Manufacturing Nanoporous Silica Method Thereof

(76) Inventors: Kyung Joo Yang, Gyeonggi-do (KR); Jin Soo Kim, Gyeonggi-do (KR); Jong Kil Kim, Gyeonggi-do (KR); Dong Hee Shin, Gyeonggi-do (KR)

Correspondence Address: John W. Renner;Renner, Otto, Boisselle & Sklar, 1621 Euclid Avenue, 19th Floor, Cleveland, OH, 44115, US

(21) Appl. No.: 12/085,710

(22) PCT Filed: Dec. 2, 2005
(86) PCT No.: PCT/KR2005/004107

§ 371 Date: May 28, 2008

(30) Foreign Application Priority Data
Dec. 1, 2005 (KR) 10-2005-0116364

(51) Int. Cl. C01B 33/12; B01J 19/00

(52) U.S. Cl. 423/338; 422/134

(57) ABSTRACT

The present invention relates to an apparatus and a method for manufacturing amorphous nanoporous silica enabling mixing of source materials with accurate equivalence ratio by generating an eddy current using high-speed reaction nozzles and capable of controlling physical properties using a continuous circulation polymerizer which performs high-speed stirring and low-speed stirring and amorphous nanoporous silica prepared by the method, which has a BET surface area of 100-850 m²/g, a pore size of 2-100 nm and a pore volume of 0.2-2.5 mL/g.

### TECHNICAL FIELD

The present invention relates to an apparatus and a method for manufacturing amorphous nanoporous silica enabling mixing of source materials with accurate equivalence ratio by generating an eddy current using high-speed reaction nozzles and capable of controlling physical properties using a continuous circulation polymerizer which performs high-speed stirring and low-speed stirring and amorphous nanoporous silica prepared by the method.

### BACKGROUND ART

Methods for manufacturing silica can be roughly classified into the wet process and the dry process. Gel type silica and precipitated silica can be prepared by the wet process. Both the gel type silica and the precipitated silica are prepared from sodium silicate (Na₂O.nSiO₂) and sulfuric acid (H₂SO₄). While the gel type silica is prepared by gelation in an alkaline condition with a relatively high silica concentration, the precipitated silica is precipitated as solid by stirring at a relatively low concentration. And, whereas the gel type silica can be prepared in both acidic and alkaline conditions, the precipitated silica can be prepared only in an alkaline condition. Also, while the manufacturing process of the gel type silica requires a long reaction time (20-80 hours) for gelation and grinding, the precipitated silica can be prepared in a short time (1-5 hours) because it is precipitated as the reaction proceeds.

In the conventional manufacturing process of precipitated silica (see FIG. 4), sodium silicate and sulfuric acid are fed directly to the polymerization tank equipped with a stirrer via different feed pipes. In this case, the region where the sulfuric acid is fed tends to be acidic and the region where the sodium silicate is fed tends to be alkaline and, consequently, the equivalence ratio of the sulfuric acid and the sodium silicate inside the reactor varies depending on the location.

Thus, control of the equivalence ratio of the sodium silicate and the sulfuric acid becomes difficult and it is impossible to obtain nanoporous silica with uniform physical properties. It is because pH is the most important factor that affects coagulation, growth and gelation of Si(OH)₄ particles formed by acidic decomposition of sodium silicate (The Chemistry of Silica; Ralph. K. Iler, John Wiley and Sons, New York, p. 177-200, 1979.). The pH at the moment when sodium silicate and sulfuric acid contact each other is a very important factor in controlling the physical properties of nanoporous silica. FIG. 6 shows the gelation time (gel time) required for the silica sol having a lot of silinol groups (—Si—OH), which is formed at the early stage, to be transformed into solid during the wet process of silica manufacturing. When the pH is in the range from 0 to 2, the gel time is longer because of increased sol stability. The gel time is longest at pH 2, or the isoelectric point of silica, where it is the most stable. In the region where the pH is from 2 to 6, the gel time decreases as the sol stability decreases and increases again from pH 6 as the stability of silica sol increases.

If sodium silicate and inorganic acid are fed via different feed pipes, as in the conventional manufacturing process of precipitated silica, it is difficult to control the pH of each site at each moment. As a result, formation of 3-4 nm sized primary particles and transformation into the 3-dimensional network structure are changeable at every minute, and thus, control of the physical properties and morphology of the nanoporous silica is impossible. Also, it is impossible to attain uniform physical properties with the conventional manufacturing process of precipitated silica when the reaction is performed at high speed, because the pH changes abruptly inside the reactor.

As for gel type silica, additional washing and drying processes are required following the transfer and grinding of the obtained wet gel. In general, it takes about 20-40 hours for the washing.

The conventional nanoporous silica, gel type silica and precipitated silica altogether, is manufactured in batch type. No matter how closely the process is controlled, variation in physical properties from one batch to another is inevitable. Thus, manufacturing of conventional gel type silica and precipitated silica has its limits. For example, Korean Patent No. 0244062 discloses a manufacturing method of nanoporous silica comprising the steps of: i) preparing an initial mother liquor comprising less than 100 g/L of silicate and less than 17 g/L of electrolytes, ii) adding an acidulator to the mother liquor until the pH of the reaction mixture becomes about 7 or higher and iii) simultaneously adding an acidulator and silicate to the reaction mixture. However, when an acidulator and silicate are simultaneously added to the reactor containing the mother liquor, locally non-uniform equivalence ratios are created during the mixing with the mother liquor. According to the silica polymerization theory as depicted in FIG. 6, different pH's result in different polymerization rates and different formation patterns of primary particles. Therefore, there can be some variation in physical properties of the nanoporous silica of different batches at all times.

### DISCLOSURE OF THE INVENTION

To solve the problem, the present inventors developed an apparatus for manufacturing amorphous nanoporous silica comprising a high-speed instantaneous reactor, which is equipped with nozzles that generate an eddy current of the source materials for them to be mixed with an accurate equivalence ratio, and a high-speed/low-speed stirring continuous circulation polymerizer, which enables uniform control of physical properties.

Thus, it is an object of the present invention to provide an apparatus for manufacturing amorphous nanoporous silica comprising a source material feeder equipped with fluctuation-proof air chambers, a high-speed instantaneous reactor equipped with nozzles and a continuous circulation polymerizer that offers high-speed stirring and low-speed stirring following the reaction for uniform physical properties.

It is another object of the present invention to provide a method for manufacturing amorphous nanoporous silica having uniform physical properties with a BET surface area of 100-850 m²/g, a pore size of 2-100 nm and a pore volume of 0.2-2.5 mL/g and amorphous nanoporous silica manufactured by the method.

To attain the objects, the present invention provides an apparatus for manufacturing amorphous nanoporous silica comprising: a source material feeder composed of a quantitative silicate feeder, a quantitative inorganic acid feeder, quantitative pumps that control the equivalence ratio of silicate and inorganic acid and fluctuation-proof air chambers that control the fluctuation generated by the quantitative pumps; a high-speed instantaneous reactor which is connected to the source material feeder and is equipped with nozzles that generate an eddy current of the silicate and the inorganic acid; and a continuous circulation polymerizer which is connected with the high-speed instantaneous reactor and is composed of a high-speed stirring reaction tank with a maximum stirring rate of 100 to 20000 rpm, a low-speed stirring reaction tank that offers a stirring at 10 to 100 rpm and a circulation pump that offers a continuous circulation for the high-speed stirring reaction tank and the low-speed stirring reaction tank.

The present invention also provides a method for manufacturing amorphous nanoporous silica comprising: a source material feeding step of feeding the source materials, i.e., silicate and inorganic acid, using quantitative feeders while controlling the fluctuation associated with the source material feeding; a high-speed instantaneous reaction step of generating an eddy current of the supplied silicate and inorganic acid using nozzles; and a continuous circulation polymerization step of stirring the resultant silica sol at a high rate of 100 to 20000 rpm and stirring the resultant nanoporous silica at a low rate of 10 to 100 rpm for the control of physical properties.

The present invention further provides amorphous nanoporous silica which is prepared by the afore-mentioned method and has a BET surface area of 100-850 m²/g, a pore size of 2-100 nm and a pore volume of 0.2-2.5 mL/g.

Hereunder is given a more detailed description of the present invention.

The apparatus for manufacturing nanoporous silica of the present invention comprises a source material feeder equipped with fluctuation-proof air chambers, a high-speed instantaneous reactor equipped with nozzles and a continuous circulation polymerizer which performs high-speed and low-speed stirring following the reaction in order to offer uniform physical properties. It further comprises a filter, a washer, a drier, a grinder and a classifier.

The quantitative pumps connected with the quantitative silicate feeder and the quantitative inorganic acid feeder and capable of accurately controlling the equivalence ratio of silicate and inorganic acid and the fluctuation-proof air chambers specially designed to accurately control the fluctuation generated by the quantitative pumps enable accurate and quantitative feeding of the source materials, i.e., the silicate and the inorganic acid, to the high-speed instantaneous reactor. The silicate and the inorganic acid are fed, at a pressure of at least 0.5 kg/cm², to the nozzles inside the high-speed instantaneous reactor, which are designed to generate an eddy current. The silicate may be sodium silicate, potassium silicate, lithium silicate, rubidium silicate or cesium silicate and the inorganic acid may be sulfuric acid, hydrochloric acid, phosphoric acid, acetic acid, perchloric acid, chloric acid, chlorous acid, hypochlorous acid, citric acid or nitric acid. The eddy current generated by the nozzles enables instantaneous mixing of the silicate and the inorganic acid, thereby enabling formation of uniform primary particles and making it easier to control the physical properties of the secondary particles formed by coagulation of the primary particles. The injection speed of the nozzles can be controlled with the feed rate of the quantitative pumps or with the diameter of the nozzles.

The pH and temperature of the continuous circulation polymerizer are controlled as follows. When manufacturing nanoporous silica having a surface area of 500 m²/g or larger, the pH is adjusted to the acidic condition of pH 2-5 and the temperature is controlled relatively low at 40° C. or below. And, when manufacturing nanoporous silica having a surface area smaller than 500 m²/g, the pH is adjusted to the basic condition of pH 7-9.5 and the temperature is controlled relatively high at 50-90° C. The continuous circulation polymerizer is equipped with a circulation pump, between the high-speed stirring reaction tank that offers a stirring at 100 to 20000 rpm and the low-speed stirring reaction tank that offers a stirring at 10 to 100 rpm, which offers a continuous circulation, thereby offering uniform, ideal physical properties in a short period of time. The high-speed stirring reaction tank is used to maintain overall uniformity and the low-speed stirring reaction tank is used to control the polymerization rate of silica by controlling the temperature and pH. Thus, without the high-speed stirring reaction tank or the low-speed stirring reaction tank, it is impossible to stir a large amount of silica at high rate.

When the polymerization process is completed, the silica is automatically transferred to a storage tank for filtering by the 3-way valve installed at the bottom of the low-speed stirring reaction tank. Salt ions included in the nanoporous silica or in the solution containing the silica are removed by a filter press to give nanoporous silica hydrogel, which may be the final product or may be dried to obtain xerogel or aerogel. Also, it may be further grinded to obtain finer particles. The resultant products are hydrophilic, but they may be transformed hydrophobically using a surface modifier.

As described above, the apparatus for manufacturing nanoporous silica in accordance with the present invention enables accurate control of the equivalence ratio of source materials using fluctuation-proof air chambers, offers quantitative instantaneous reaction using high-speed reaction nozzles and enables mass production of nanoporous silica with uniform physical properties in short time by continuous circulation polymerization. Also, it reduces time required for filtering and washing following the polymerization, and thus saves production cost.

### BRIEF DESCRIPTION OF THE DRAWINGS

FIG. 1 illustrates the overall manufacturing process of nanoporous silica in accordance with the present invention.

FIG. 2 illustrates the transfer of the source materials from the quantitative feeders to the high-speed instantaneous reactor.

FIG. 3 illustrates the specific construction of the high-speed instantaneous reactor.

FIG. 4 illustrates the conventional manufacturing process of precipitated silica.

FIG. 5 illustrates the conventional manufacturing process of gel type silica.

FIG. 6 shows the effect of pH on colloidal silica in water.

### BEST MODE FOR CARRYING OUT THE INVENTION

Now, the present invention is described in further detail referring to the attached drawings.

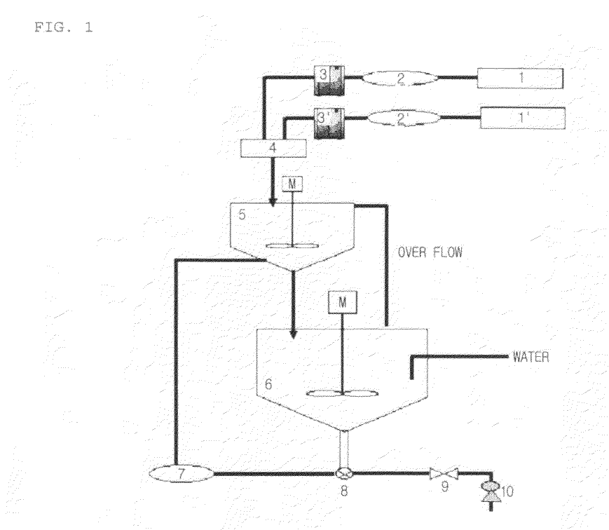

FIG. 1 illustrates the overall manufacturing process of nanoporous silica in accordance with the present invention. The source materials, silicate and inorganic acid, supplied to each quantitative feeder (1, 1′) are transferred to fluctuation-proof air chambers (3, 3′) for preventing the fluctuation caused by the silicate and the inorganic acid and uniformly fed to the high-speed instantaneous reactor (4). The silica sol emerging from the high-speed instantaneous reactor (4) passes through the high-speed stirrer (5) that offers a high-speed stirring at about 100-20000 rpm for more uniform control of the equivalence ratio and is transferred to the low-speed stirrer (6) that offers a low-speed stirring at about 10-100 rpm for polymerization. The circulation pump (7) offers a continuous circulation between the high-speed stirrer and the low-speed stirrer, and thus perfectly uniform nanoporous silica. The nanoporous silica particles, physical properties of which have been controlled by the low-speed stirrer, is re-circulated to the high-speed stirrer via the 3-way valve (8) or transferred to the storage tank (10) via the evacuation valve (9).

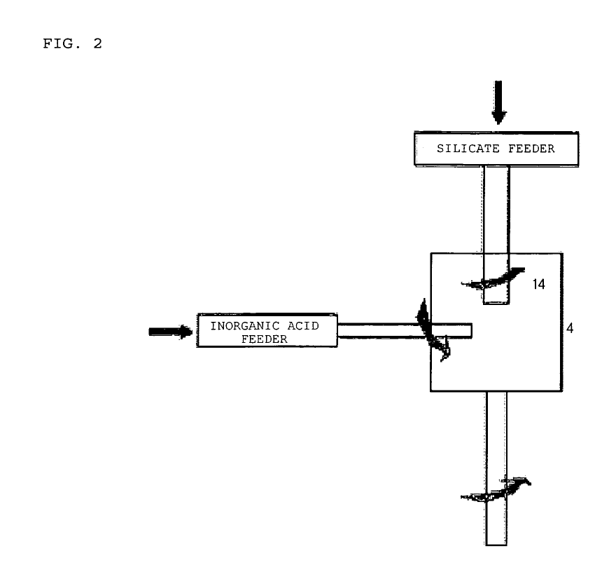

FIG. 2 illustrates the transfer of the source materials from the quantitative feeders to the high-speed instantaneous reactor. The silicate and the inorganic acid supplied to the quantitative feeder are fed to the high-speed instantaneous reactor (4) equipped with the nozzles (14) passing through the quantitative pumps (2, 2′) and the fluctuation-proof air chambers (3, 3′) at a uniform equivalence ratio. The high-speed reaction nozzles generate an eddy current of the silicate and the inorganic acid for accurate, instantaneous, quantitative mixing.

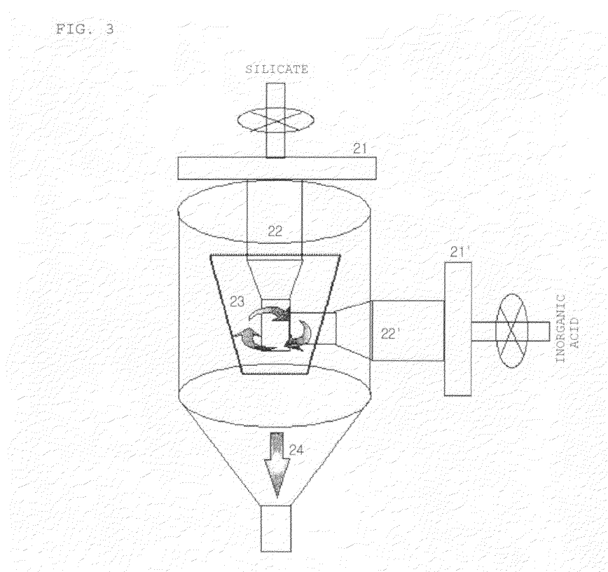

FIG. 3 illustrates the specific construction of the high-speed instantaneous reactor. The silicate and the inorganic acid are fed to each feed section (21, 21′) at a controlled flow rate and a pressure of at least 0.5 kg/cm². A liquid is uniformly injected at each spiral-shaped eddy current generating section (22, 22′). The eddy current of the silicate and the eddy current of the inorganic acid contact each other equivalently at the complete mixing section (23). The silicate and the inorganic acid are mixed uniformly once again by the eddy current there, evacuated at the evacuation section (24) located at the end of the nozzles and transferred to the continuous circulation polymerization reactor equipped with a high-speed stirring reaction tank and a low-speed stirring reaction tank.

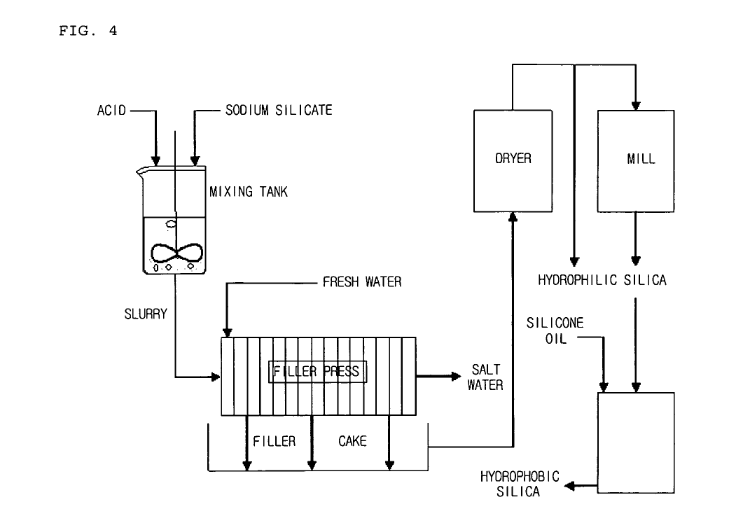

FIG. 4 illustrates the conventional manufacturing process of precipitated silica. Since silicate and inorganic acid are fed from outside into a large polymerization tank, without special control, equivalence ratio and pH distribution at the site where the silicate and the inorganic acid are supplied are always non-uniform. Thus, it is required to perform the reaction for a long time with a small amount of source materials in order to obtain uniform physical properties, which is also limited in practice.

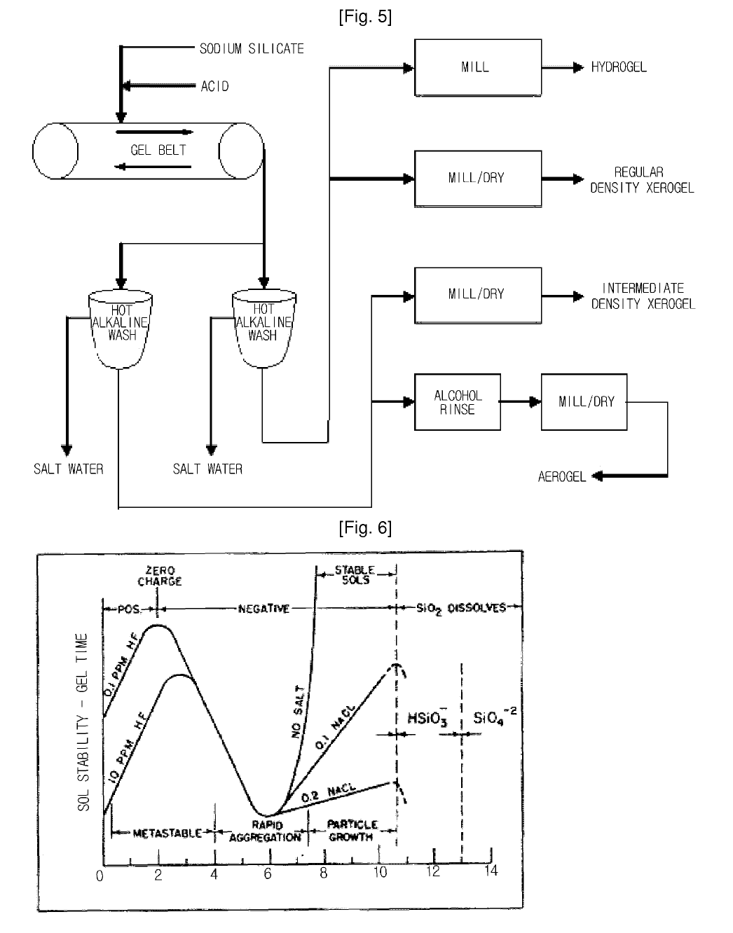

FIG. 5 illustrates the conventional manufacturing process of gel type silica. The bulk type wet gel formed from the reaction of silicate and inorganic acid is transferred to a wash tank, where it is washed with water for 20 to 60 hours of a long time. The long washing time and the complicatedness in transfer make automation difficult. Thus, this method is limited to be applied for mass production. Besides, the resultant silica has to be grinded to obtain powder.

The manufacturing process of nanoporous silica in accordance with the present invention can solve the problem of non-uniform physical properties of the conventional method, which results from non-uniform control of the equivalence ratio of silicate and inorganic acid and local difference in pH. Also, the reaction time can be reduced. Since, the silicate and the inorganic acid fed by the source material feeder react with each other quickly and are transferred to the continuous circulation polymerizer that offers high-speed stirring and low-speed stirring, productivity per unit facility is improved and mass production of products with uniform physical properties is possible. Whereas the conventional method required a polymerization time of 5 hours or more, the method of the present invention requires as little as 2 hours of time. And, whereas the conventional method is limited in manufacturing precipitated silica with a surface area of 150-400 m²/g or larger, the present invention can manufacture offer a surface area of up to 150-850 m²/g. Thus, the precipitated silica prepared by the present invention can be utilized in a variety of applications, including plastics, paints, pigments, protein removers, toothpaste abrasives, thixotropic agents and catalyst supports.

Besides, the present invention reduces the polymerization time, which is 20-80 hours in the conventional manufacture of gel type silica, to less than 10 hours, while offering the physical properties of the gel type silica. In addition, the resultant silica can be easily prepared into powder without forming a lump.

Hereinafter, the present invention is described in further detail through examples. However, the following examples are only for the understanding of the present invention and they are not to be construed as limiting the present invention.

### Example 1

Sodium silicate with a SiO₂/Na₂O molar ratio of 3.4 and a solid content of 210 g/L and 110 g/L of sulfuric acid solution were used. Reaction was performed using a high-speed instantaneous quantitative continuous reactor. In order to prevent fluctuation generated by the quantitative pumps, the air pressure inside the air chambers was adjusted to 0.5 kg/cm² before feeding sodium silicate and sulfuric acid. After contravening that the fluctuation had been controlled and the source materials were feed constantly with time, an eddy current of the sodium silicate and sulfuric acid were generated at the high-speed instantaneous reactor equipped with nozzles for instantaneous quantitative mixing. The equivalence ratio of sodium silicate and sulfuric acid was adjusted with a torque control lever attached to the quantitative pumps to pH 6. The reaction mixture was stirred at 200 rpm in the continuously connected high-speed stirring reaction tank and transferred to the low-speed stirring reaction tank by free falling and overflow. At the same time, the reaction mixture was continuously circulated by a circulation pump located between the low-speed stirring reaction tank and the high-speed stirring reaction tank, in order to offer uniform physical properties. Water was continuously supplied to the low-speed stirring reaction tank in order to control the solid content of silica, so that the concentration of silica was maintained at 15 g per a liter of water. The pH inside the low-speed stirring reaction tank was controlled at pH 3-5 and the temperature was maintained at 40° C., while continuously stirring at about 60 rpm. The stirring was performed for 30 minutes.

The reaction mixture was transferred to the filter press located at below the low-speed stirring reaction tank via a 3-way automatic transfer. Sulfate ion and sodium ion present within the nanoporous silica were washed away with 25° C. of water. When the pH of the washing water reached about pH 6.5-7.5, washing was stopped and the resultant nanoporous silica slurry was dried with a spray drier at 300° C. The obtained nanoporous silica had an almost spherical bead shape. For the measurement of the DBP absorption of the nanoporous silica, 100 mL of dried DBP sample was grinded to a size below 325 mesh by ISO 787/V. Consumption of DBP oil for 10 g of the sample was interpreted as endpoint. The DBP absorption was computed as 103 mL/100 g. BET surface area was measured by the Brunauer-Emmet-Teller process (Journal of the American Chemical Society, vol. 60, p. 309, February 1938.) using a measurement device (Micrometrics ASAP 2400). The measurement was carried out up to 5 points after pre-treatment by taking 0.08 g weight of sample. As a result, the BET surface area was 750 m²/g, the pore size was 2.04 nm and the pore volume was 0.4 mL/g.

### Example 2

Sodium silicate with a SiO₂/Na₂O molar ratio of 3.4 and a solid content of 233 g/L and 135 g/L of sulfuric acid solution were used. Reaction was performed using a high-speed instantaneous quantitative continuous reactor. In order to prevent fluctuation generated by the quantitative pumps, the air pressure inside the air chambers was adjusted to 0.5 kg/cm² before feeding sodium silicate and sulfuric acid. After contravening that the fluctuation had been controlled and the source materials were feed constantly with time, an eddy current of the sodium silicate and sulfuric acid were generated at the high-speed instantaneous reactor equipped with nozzles for instantaneous quantitative mixing. The equivalence ratio of sodium silicate and sulfuric acid was adjusted with a torque control lever attached to the quantitative pumps to pH 8.5.

The reaction mixture was stirred at 400 rpm in the continuously connected high-speed stirring reaction tank and transferred to the low-speed stirring reaction tank by free falling and overflow. At the same time, the reaction mixture was continuously circulated by a circulation pump located between the low-speed stirring reaction tank and the high-speed stirring reaction tank, in order to offer uniform physical properties. Water was continuously supplied to the low-speed stirring reaction tank in order to control the solid content of silica, so that the concentration of silica was maintained at 25 g per a liter of water. The pH inside the low-speed stirring reaction tank was controlled at pH 9.5 and the temperature was maintained at 90° C. The reaction mixture was stirred continuously at the rate 60 rpm for 50 minutes.

The reaction mixture was transferred to the filter press located at below the low-speed stirring reaction tank via an 3-way automatic transfer. Sulfate ion and sodium ion present within the nanoporous silica were washed away with 95° C. of water. When the pH of the washing water reached about pH 7-8, washing was stopped and the resultant nanoporous silica slurry was dried with a spray drier at 300° C. The obtained nanoporous silica had an almost spherical bead shape. For the measurement of the DBP absorption of the nanoporous silica, 100 mL of dried DBP sample was grinded to a size below 325 mesh by ISO 787/V. Consumption of DBP oil for 10 g of the sample was interpreted as endpoint. The DBP absorption was computed as 220 mL/100 g. BET surface area was measured by the Brunauer-Emmet-Teller process using a measurement device (Micrometrics ASAP 2400). The measurement was carried out up to 5 point after pretreatment by taking 0.09 g weights of sample. As a result, the BET surface area was 250 m²/g, the pore size was 10.2 nm and the pore volume was 0.9 mL/g.

### Example 3

Sodium silicate with a SiO₂/Na₂O molar ratio of 3.4 and a solid content of 270 g/L and 145 g/L of sulfuric acid solution were used. Reaction was performed using a high-speed instantaneous quantitative continuous reactor. In order to prevent fluctuation generated by the quantitative pumps, the air pressure inside the air chambers was adjusted to 0.5 kg/cm² before feeding sodium silicate and sulfuric acid. After contravening that the fluctuation had been controlled and the source materials were feed constantly with time, an eddy current of the sodium silicate and sulfuric acid were generated at the high-speed instantaneous reactor equipped with nozzles for instantaneous quantitative mixing. The equivalence ratio of sodium silicate and sulfuric acid was adjusted with a torque control lever attached to the quantitative pumps to pH 7.5.

The reaction mixture was stirred at 200 rpm in the continuously connected high-speed stirring reaction tank and transferred to the low-speed stirring reaction tank by free falling and overflow. At the same time, the reaction mixture was continuously circulated by a circulation pump located between the low-speed stirring reaction tank and the high-speed stirring reaction tank, in order to offer uniform physical properties.

Water was continuously supplied to the low-speed stirring reaction tank in order to control the solid content of silica, so that the concentration of silica was maintained at 20 g per a liter of water. The pH inside the low-speed stirring reaction tank was controlled at pH 8.5 and the temperature was maintained at 90° C., while continuously stirring at about 60 rpm. The stirring was performed for 110 minutes.

The reaction mixture was transferred to the filter press located at below the low-speed stirring reaction tank via an 3-way automatic transfer. Sulfate ion and sodium ion present within the nanoporous silica were washed away with 90° C. of water. When the pH of the washing water reached about pH 7-8, washing was stopped and the resultant nanoporous silica slurry was dried with a spray drier at 300° C. The obtained nanoporous silica had an almost spherical bead shape. For the measurement of the DBP absorption of the nanoporous silica, 100 mL of dried DBP sample was grinded to a size below 325 mesh by ISO 787/V. Consumption of DBP oil for 10 g of the sample was interpreted as endpoint. The DBP absorption was computed as 320 mL/100 g. BET surface area was measured by the Brunauer-Emmet-Teller process using a measurement device (Micrometrics ASAP 2400). 0.09 g was weighed and measurement was made up to 5 points after pre-treatment. As a result, the BET surface area was 330 m²/g, the pore size was 12.5 nm and the pore volume was 1.25 mL/g.

Table 1 below shows the manufacturing condition and physical properties of the nanoporous silica prepared in Examples 1 to 3.

TABLE 1

| | Example 1 | Example 2 | Example 3 |
|---|---|---|---|
| Silicate concentration (g/L) | 210 | 233 | 270 |
| Sulfuric acid concentration | 110 | 135 | 145 |
| (g/L) | | | |
| pH after reaction | 6 | 8.5 | 7.5 |
| Solid content of silica (g/L) | 15 | 25 | 20 |
| pH, low-speed stirring | 3-5 | 9.5 | 8.5 |
| Temperature, low-speed | 40 | 90 | 90 |
| stirring (° C.) | | | |
| Reaction time (min) | 30 | 50 | 110 |
| pH after wash | 6.5-7.5 | 7-8 | 7-8 |
| Temperature, washing water | 25 | 95 | 90 |
| (° C.) | | | |
| DBF absorption (mL/100 g) | 103 | 220 | 320 |
| BET surface area (m²/g) | 750 | 250 | 330 |
| Pore size (nm) | 2.04 | 10.2 | 12.5 |
| Pore volume (mL/g) | 0.4 | 0.9 | 1.25 |

While the present invention has been described in detail with reference to the preferred embodiments, those skilled in the art will appreciate that various modifications and substitutions can be made thereto without departing from the spirit and scope of the present invention as set forth in the appended claims.

1. An for manufacturing amorphous nanoporous silica comprising:
a source material feeder composed of a quantitative silicate feeder, a quantitative inorganic acid feeder, quantitative pumps that control the equivalence ratio of silicate and inorganic acid and fluctuation-proof air chambers that control the fluctuation generated by the quantitative pumps;
a high-speed instantaneous reactor which is connected to the source material feeder and is equipped with nozzles that generated an eddy current of the silicate and the inorganic acid; and
a continuous circulation polymerizer which is connected with the high-speed instantaneous reactor and is composed of a high-speed stirring reaction tank with a maximum stirring rate of 100 to 20000 rpm, a low-speed stirring reaction tank that offers a stirring at 10 to 100 rpm and a circulation pump that offers a continuous circulation for the high-speed stirring reaction tank and the low-speed stirring reaction tank.

2. The apparatus of claim 1, wherein the manufactured nanoporous silica has a BET surface area of 100-850 m²/g, a pore size of 2-100 nm and a pore volume of 0.2-2.5 mL/g.

3. The apparatus of claim 1, which further comprises a 3-way valve that is connected with the bottom of the low-speed stirring reaction tank and circulates or evacuates the nanoporous silica whose physical properties are controlled by the low-speed stirring reaction tank.

4. The apparatus of claim 1, wherein the silicate is selected from a group consisting of sodium silicate, potassium silicate, lithium silicate, rubidium silicate and cesium silicate.

5. The apparatus of claim 1, wherein the inorganic acid is selected from a group consisting of sulfuric acid, hydrochloric acid, phosphoric acid, acetic acid, perchloric acid, chloric acid, chlorous acid, hypochlorous acid, citric acid and nitric acid.

6. A method for manufacturing amorphous nanoporous silica comprising:
a source material feeding step of feeding the source materials, i.e., silicate and inorganic acid, with quantitative feeders while controlling the fluctuation associated with the source material feeding;
a high-speed instantaneous reaction step of generating an eddy current of the supplied silicate and inorganic acid using nozzles; and
a continuous circulation polymerization step of stirring the resultant silica sol at a high rate of 100 to 20000 rpm and stirring the resultant nanoporous silica at a low rate of 10 to 100 rpm for the control of physical properties.

7. (canceled)
